(19) United States
(12) Patent Application Publication
(10) Pub. No.: US 2011/0247386 A1
(43) Pub. Date: Oct. 13, 2011

(54) GRIPPING DEVICES

(75) Inventor: Nigel A. Buchanan, Fife (GB)

(73) Assignee: AMERICAN GREASE STICK COMPANY, Muskegon, MI (US)

(21) Appl. No.: 13/127,311

(22) PCT Filed: Nov. 3, 2009
(86) PCT No.: PCT/GB09/02604

§ 371 Date: Jun. 28, 2011

(30) Foreign Application Priority Data
Nov. 4, 2008 (GB) 0820170.9

(51) Int. Cl. B21D 11/00; B23B 31/02; B23P 11/00; B25B 1/00

(52) U.S. Cl. 72/307; 269/86; 279/133; 29/428

(57) ABSTRACT

A gripping device comprises a support frame defining an axially extending internal space for receiving a part that is to be gripped and a plurality of jaws carried by the support frame. The jaws each have an end face and are connected with the support frame such that an axially directed force applied to the end faces causes axially and radially inward movement of the jaws for gripping a part received in the internal space.

### FIELD OF THE INVENTION

The invention relates to gripping devices such as chucks and clutches.

### BACKGROUND OF THE INVENTION

Known self-centring chucks may comprise a plurality of segments of a cylinder body that each have a tapering external wall portion. The segments are held in a sleeve which has an internal taper that complements the taper on the segments. The sleeve has an internal wall that is threaded and screwed onto a thread on a base member. The sleeve is movable in axial directions of the chuck by screwing it back and forth on the base member. In an open condition of the chuck, the segments are biased to spaced apart positions in which they define an axially extending through-hole for receiving parts that are to be gripped. An inward screwing movement of the sleeve relative to the base member causes the segments to be compressed radially inwardly to close the through-hole and grip a part received therein. The part is released by screwing the sleeve in the opposite direction. Such chucks may be used for lightweight applications such as on hand drills.

Another form of self-centring chuck comprises a body that has a rear spigot for fitting on a drive spindle. The body defines three or more radially extending guide slots that house respective chuck jaws. The jaws each have arcuate grooves formed in a rear face thereof that mate with a scroll thread provided on a rotatable plate held within the chuck body. The plate can be rotated by means of a chuck key to cause the chuck jaws to move radially inwardly and outwardly with respect to an axially extending through hole defined by the chuck body. Such chucks are often relatively large, heavy and expensive constructions used on machine tools such as lathes.

### SUMMARY OF THE INVENTION

The invention provides a gripping device comprising a support frame defining an axially extending internal space for receiving a part that is to be gripped and a plurality of jaws carried by said support frame, said jaws each having an end face and being connected with said support frame such that an axially directed force applied to said end faces causes axially and radially inward movement of said jaws for gripping a said part received in said internal space.

The invention also includes a gripping device comprising a support frame and a plurality of jaws carried by said support frame, said support frame comprising a plurality of meshing plate members.

The invention also includes holding apparatus for holding an elongate element against axial movement, said holding apparatus comprising a support having an internal space for receiving a said elongate element and a plurality of jaws mounted to the support for axial and radial movement relative to the support, wherein axial movement of the jaws into the support causes the jaws to move radially inwardly of the support for engaging and holding a said elongate element received is said space.

The invention also includes a method of manufacturing a chuck or clutch, said method comprising providing a plurality of plates members, forming a support frame by connecting a first plurality of said plate members and pivotally connecting a second plurality of said plate members to said support frame to define a plurality of pivoting jaws.

### BRIEF DESCRIPTION OF THE DRAWINGS

In order that the invention may be well understood, embodiments thereof, which are given by way of example only, will now be described with reference to the drawings in which:

FIG. 1 is a schematic sectional-type view of a gripping device provided in a pipe flaring apparatus with the pipe flaring apparatus shown in a rest condition;

FIG. 2 is an exploded perspective view of a portion of the pipe flaring apparatus of FIG. 1 in which the gripping device is held;

FIG. 3 is an enlarged perspective view showing the gripping device;

FIG. 4 is a view corresponding to FIG. 1 showing the gripping device gripping a pipe in the pipe flaring apparatus;

FIG. 5 is a view corresponding to FIG. 4 showing the pipe flaring apparatus in a condition in which a pipe flaring tool has been driven into the end of the pipe.

FIG. 6 is a schematic illustration of a modification of the gripping device shown in FIG. 3 to form a chuck; and

FIG. 7 is a schematic illustration of a modification of the gripping device shown in FIG. 3 to form a clutch.

### DETAILED DESCRIPTION OF THE ILLUSTRATED EMBODIMENTS

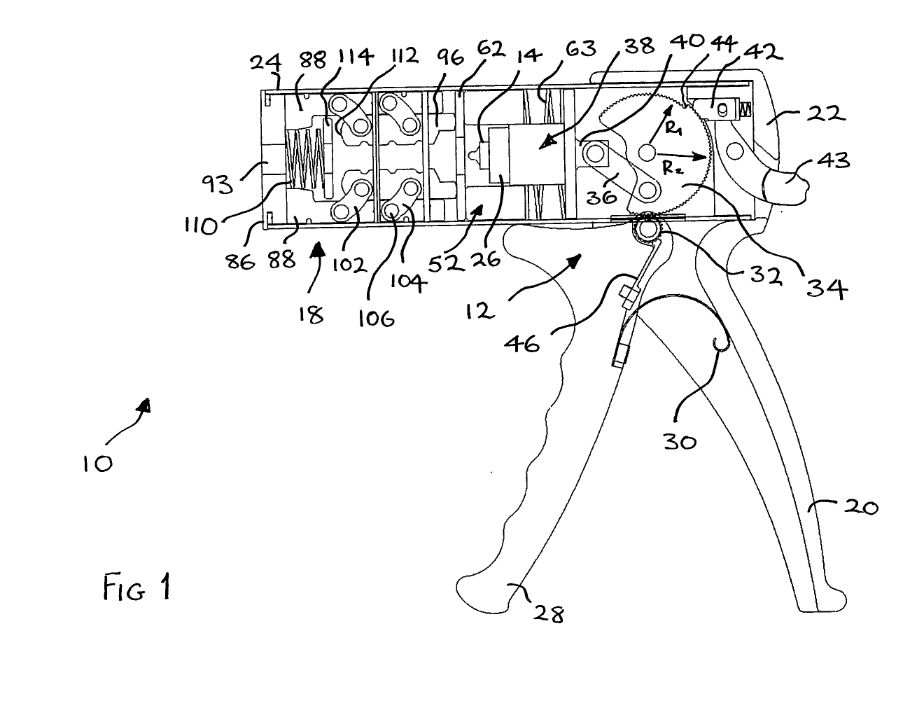

A first embodiment of a gripping device according to the invention will now be described with reference to FIGS. 1 to 5. In these Figures, the gripping device is shown used as a pipe holder in a pipe flaring apparatus.

Referring to FIG. 1, a pipe flaring apparatus 10 comprises a hand-powered actuator 12 for driving a pipe flaring tool 14 into an end of a pipe 16 (FIG. 4) that is held in the pipe flaring apparatus by a pipe holder 18. In FIG. 1, the pipe flaring apparatus 10 is shown in a rest condition.

The pipe flaring apparatus 10 comprises a handle 20 having an integral sleeve member 22 that receives an end of a barrel 24. The handle 20 and sleeve 22 may, for example, be a plastics moulding or a metal casting and the barrel may, for example, comprise a metal tube. A portion of the hand-powered actuator 12 is housed in the barrel 24 at a first end of the barrel and the pipe holder 18 is disposed at a second, opposite, end of the barrel. A tool holder 26 for holding a plurality of flaring tools 14 is disposed intermediate the hand-powered actuator 12 and pipe holder 18.

The hand-powered actuator 12 comprises a lever, or trigger, 28 that is pivotally connected to the handle 20 such that it can be moved towards the handle in response to a hand-applied input force. A return member, for example a leaf spring 30, is provided between the handle 20 and trigger 28 for moving the trigger away from the handle and returning the trigger to the rest position shown in FIG. 1.

The hand-powered actuator 12 further comprises a toothed wheel 32 mounted for rotation on the handle 20 and a toothed member 34 that is mounted for rotation in the barrel 24. The toothed wheel 32 projects through a slot in the barrel 24 and engages the teeth of the toothed member 34. As viewed in FIG. 1, movement of the trigger 28 towards the handle 20 causes anti-clockwise rotation of the toothed wheel 32, which causes clockwise rotation of the toothed member 34. The toothed member 34 is pivotably connected with one end of a link arm, or crank, 36. The other end of the crank 36 is pivotably connected with a stepped piston 38 that is mounted for axial sliding movement in the barrel 24. The piston 38 includes a spigot 40 to which the crank 36 is connected and the toothed member 34 includes a cut-out into which the spigot extends.

A spring loaded ratchet member 42 is mounted within the barrel 24 such that it is spring-biased into engagement with the toothed member 34. A release lever 43 is connected to the ratchet member 42 to provide user controlled release of the ratchet member 34. The ratchet member 42 is configured such that the toothed member 34 can rotate clockwise while in engagement with the ratchet member and can only rotate anticlockwise if the ratchet member is released by operation of the release lever 43. The release lever 43 is operable to move the ratchet member 42 to two release positions corresponding to two different radii R₁ and R₂ of the toothed member 34. When the ratchet member 42 is engaging the teeth on the radius R₁ the user can move the release lever 43 to a first release position in which the ratchet member 42 is withdrawn to a position in which it no longer engages those teeth leaving the toothed member 34 free to rotate anti-clockwise until a step 44 formed where the two radii R₁ and R₂ meet engages in a recess 45 provided in the ratchet member (this engagement is illustrated in FIG. 4). If the user operates the release lever 43 to move the ratchet member 42 to a second release position, the ratchet member is withdrawn to a position in which the ratchet member will not engage the toothed member 34, which is then free to rotate anti-clockwise to positions in which the teeth on the radius R₂ are moved past the ratchet member.

A resilient ratchet arm 46 is mounted on the trigger 28 in engagement with the toothed wheel 32. The ratchet arm 46 is configured to engage the toothed wheel 32 and turn it anticlockwise when the trigger 28 is moved towards the handle 20 and to slide over the toothed wheel when the trigger is moved away from the handle and the toothed member 34 is held by the ratchet member 42. When the toothed member 34 is released by the ratchet member 42, the ratchet arm 46 allows the teeth of the toothed wheel 32 to slide past it as the toothed wheel is rotated clockwise by the anticlockwise rotation of the toothed member 34.

Referring to FIG. 2, the stepped piston 38 comprises a larger diameter portion 48 from which the spigot 40 (not visible in FIG. 2) projects and a smaller diameter portion 50 that extends from the larger diameter portion in the opposite direction to the spigot 40 and towards the pipe holder 18. The smaller diameter portion 50 of the piston 38 is a sliding fit in a pusher 52. The pusher 52 comprises a generally cylindrical body provided with an axially extending aperture 54 that extends from the end of the pusher 52 that faces away from the pipe holder 18 and opens into a transverse slot 56 that extends through the end of the pusher that faces the pipe holder. The slot 56 is sized to receive the tool holder 26 and defines a pair of opposed generally D-shaped pusher members 58, 60 that engage a washer 62 (FIG. 1) to apply an axially directed force to jaws of the pipe holder 18. A resilient force transmitting member 63 (FIG. 1) is fitted over the smaller diameter portion 50 of the piston and engages opposed faces of the larger diameter portion 48 of the piston and the pusher 52 to transmit an axially directed pushing force from the piston 38 to the pusher. In the illustrated embodiment, the force transmitting member 63 is a compression spring.

Still referring to FIG. 2, the tool holder 26 is slideably located on two conical projections 64 provided on the free end face 66 of the small diameter portion 50 of the piston 38 so that axial movement of the piston causes the tool holder to move in the axial direction of the pusher 52 (ie perpendicular to the axis of the transverse slot 56). The conical projections 64 taper towards the end face 66 and are configured to be received in a dovetail groove 68 that extends in the lengthways direction of the tool holder 26. The engagement of the conical projections 64 and dovetail groove 68 is such that the tool holder 26 can slide across the end face 66 of the piston 38 in a direction substantially perpendicular to the longitudinal axis of the piston.

The tool holder 26 is provided with three spaced apart blind holes 70 for receiving pipe flaring tools, such as the pipe flaring tool 14, to allow the tool holder to carry three tools at a time. Respective threaded holes 72 extend at right angles to the tool receiving holes 70. A grub screw (not shown) or other suitable fastener, can be screwed into a threaded hole 72 to engage in a circumferentially extending groove 74 provided in pipe flaring tool 14 to secure the tool in the associated tool receiving hole. The base of the dovetail groove 68 is provided with respective recesses (not shown) aligned with the axes of the tool receiving holes 70. A spring loaded detent ball 76 is provided in the end face 66 of the piston 38 so that as the tool holder 26 is slid through the transverse slot 56, a user can align a desired pipe flaring tool 14 carried on the tool holder 26 with the axis of the pipe holder 18 and piston 38 by feeling the detent ball 76 click into the respective recess in the dovetail groove 68.

The barrel 24 is provided with opposed rectangular windows 78 (only one being visible in FIG. 2) through which the tool holder 26 can be inserted to engage the dovetail 68 with the conical projections 64. This allows the tool holder 26 to be slid back and forth for aligning the tools it carries with the pipe holding mechanism 18 and piston 38 or removed from the barrel 24 to allow different tools to be fitted in the tool receiving holes 70.

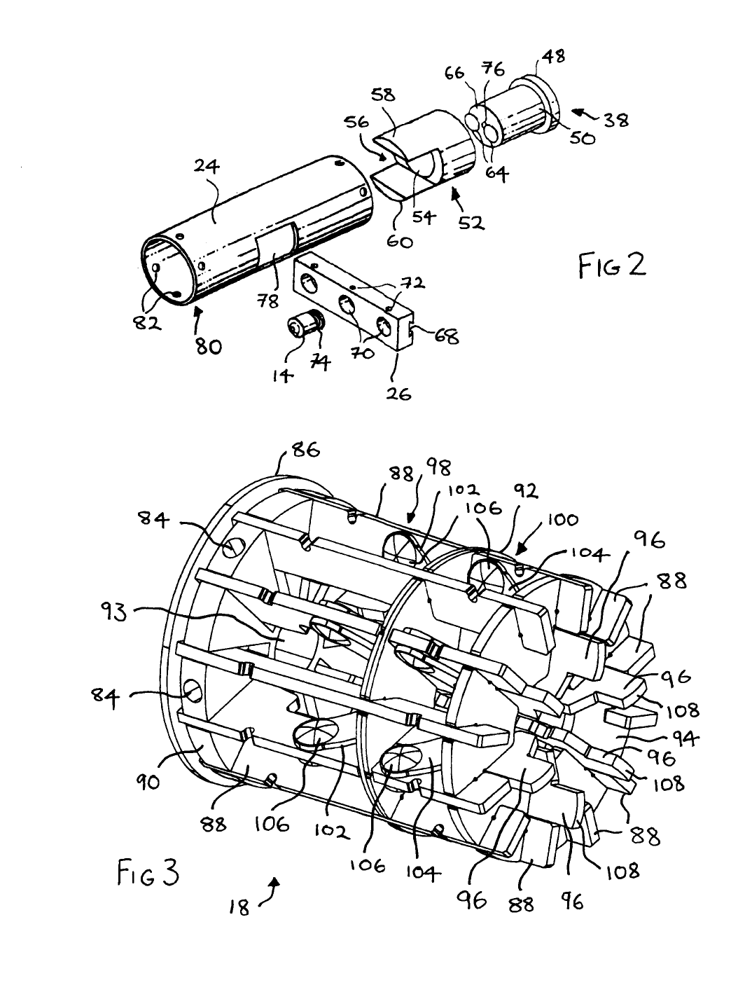

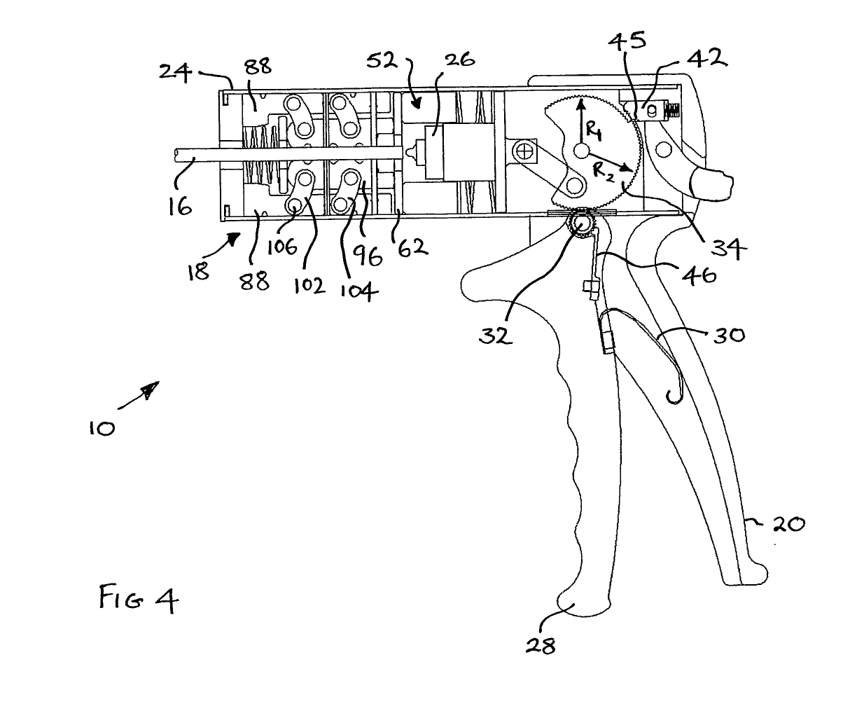

Referring to FIGS. 2 and 3, the pipe holder 18 is a sliding fit in the end 80 of the barrel 24. The pipe holder 18 is securable to the barrel 24 by means of screws or other suitable fasteners (not shown) that can be inserted through clearance holes 82 provided in the barrel and screwed into threaded holes 84 provided in the pipe holder. The pipe holder 18 includes an end plate 86 that has a diameter substantially corresponding to that of the barrel 24. The end plate 86 limits insertion of the pipe holder into the barrel 24 to assist in aligning the threaded holes 84 with the clearance holes 82.

The pipe holder 18 includes a carrying frame comprising a plurality of axially extending support plates 88 that are held in circumferentially equi-spaced relationship by three axially spaced annular carrying discs 90, 92, 94. The carrying disc 90 is integral with the end plate 86 and is provided with an axially extending through hole 93 through which pipes that are to be flared can be inserted into the pipe holder 18. Alternate ones of the support plates 88 support respective jaws 96. In the illustrated embodiment there are six jaws 96, although, this is not to be taken as limiting. Each jaw 96 is supported on two link arms 98, 100 to form a four-bar linkage. As shown in FIG. 3, the link arms 98, 100 comprise respective pairs of link members 102, 104 disposed either side of the respective support plate 88. The link members 102, 104 are connected to the support plates 88 by pivot pins 106 such that the jaws 96 can be moved axially inwardly of the carrying frame towards the end plate 86 by an axial pushing force applied by the washer 62 to respective end faces 108 of the jaws. The configuration of the four bar linkage is such that as the jaws 96 move into the carrying frame they simultaneously move radially inwardly towards the longitudinal axis of the pipe holder 18. Thus, as the jaws 96 are moved into the pipe holder 18, they will move radially inwardly to clamp on a pipe, such as the pipe 16, to clamp the pipe within the pipe holder. As shown in FIG. 1, a resilient return member 110 (not shown in FIG. 3) is provided between the carrying disc 90 and the opposed end faces 112 of the jaws 96 for returning the jaws to the open condition shown in the drawing. Although not limited to such, in the illustrated embodiment, the return member 110 comprises a compression coil spring with a disc 114 secured to its end adjacent the jaws 96. The resilient return member 110 is not as stiff as the force transmitting member 63.

The support plates 88 and carrying discs 90, 92, 94 interengage by push-fitting and utilise the barrel 24 to maintain engagement between them. The carrying discs 90, 92, 94 each define a plurality of slots that extend radially inwardly from the periphery of the discs. The support plates 88 are push-fitted into the slots. The carrying discs 90, 92, 94 are disposed perpendicular to the longitudinal axis of the pipe holder 18 and the support plates 88 are disposed parallel to and spaced from the longitudinal axis.

It will understood that the pipe holder 18 comprises a plurality of plate members that define a simple lightweight support frame that can be fabricated economically from, for example, pressed or stamped steel plates. The pipe holder jaws are similarly plate members that are attached to the jaws by link plates and pivot pins. This construction also allows for a quick and simple repair if a part becomes damaged. All that is required is that the pipe holder is released from the barrel and then the damaged part(s) can be readily pulled apart and replaced.

In use, starting from the rest condition shown in FIG. 1, the user slides the tool holder 26 into position to bring a desired tool 14 into alignment with the respective axes of the pipe holder 18 and piston 38. A pipe 16 is then inserted into the pipe holder 18 via the through hole 93. The pipe 16 is pushed into the pipe holder 18 until the user sees the leading end of the pipe is aligned with the washer 62 (this can be seen through the windows 78 and is the position shown in FIG. 4). The user then squeezes the trigger 28 towards the handle 20 to cause anticlockwise rotation of the toothed wheel 32 that, in turn, causes clockwise rotation of the toothed member 34.

As the toothed member 34 rotates, the crank 36 pushes against the spigot 40 causing the piston 38 to move towards the pipe holder 18. As the piston 38 moves towards the piped holder 18, it causes an initial compression of the force transmitting member 63 after which the pushing force of the piston is transmitted to the pusher 52 such that the piston and pusher move substantially together. The pusher 52 pushes the washer 62 against the end faces 108 of the jaws 96 and, since the force transmitting member 63 is stiffer than the return member 110, this causes the jaws to be pushed back into the pipe holder causing them to pivot into engagement with the pipe 16. Engagement of the jaws 96 with the pipe 16 provides a resistance to further movement of the jaws and once this is sufficient to overcome the force transmitting member 63. The pipe flaring apparatus 10 is then in the condition shown in FIG. 4 with the recess 45 in the ratchet member 42 engaging the step 44 at the transition between the teeth on the radius R₁ and the teeth on the radius R₂.

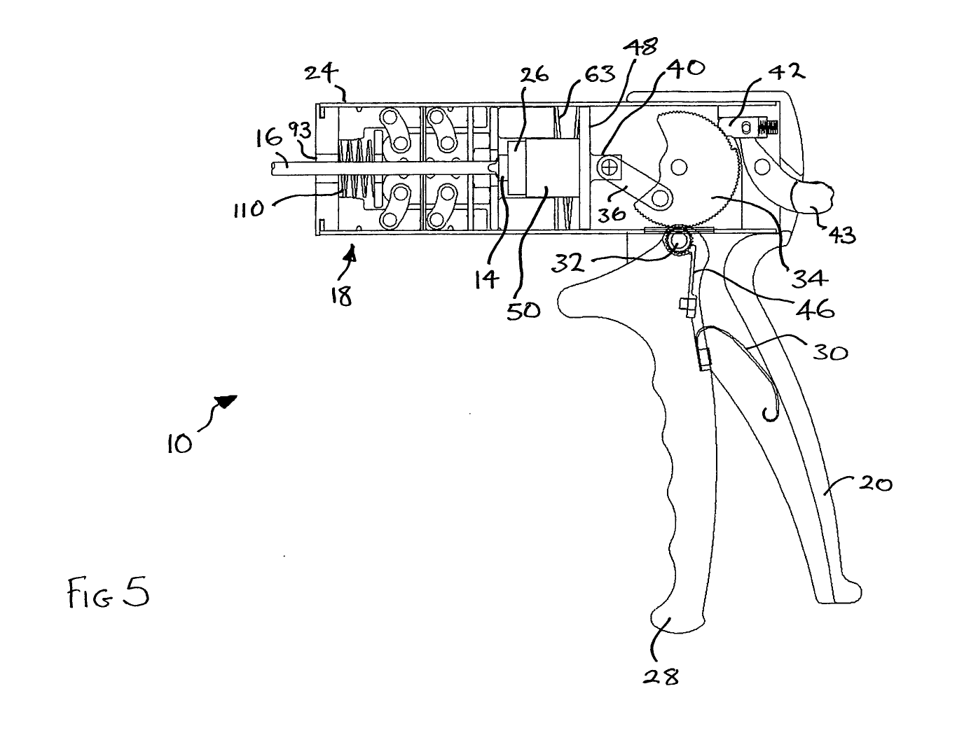

With the pipe 16 firmly clamped by the jaws 96, further movement of the piston 38 is relative to the pusher 52 and results in further compression of the force transmitting member 63. As the piston 38 moves relative to the pusher 52, the tool holder 26 is pushed further towards the pipe holder 18 to force the tool 14 into the end of the pipe 16 to produce a flare. At this stage, the pipe flaring apparatus 10 is in the condition shown in FIG. 5.

Once the flare is made (this can be seen through either of the windows 78 and can be felt in the form of increasing resistance to operation of the trigger 28) the user operates the release lever 43 to allow the toothed member 34 freedom to rotate anti-clockwise under the influence of the compression forces stored in the force transmitting member 63. If the user only wishes to make a single flare in the end of the pipe, the release lever 43 is moved to the second release position to allow the toothed member 34 to rotate anticlockwise to the position shown in FIG. 1 in which the ratchet member 42 again confronts the teeth on the radius R₂. If the user wishes to make a second flare in the end of the pipe 16, the release lever 43 is moved to the first release position. This allows the toothed member 34 to be rotated anticlockwise by the force stored in the force transmitting member 63 until the step 44 at the transition between the radius R₁ and the radius R₂ catches in the recess 45. This puts the pipe flaring apparatus 10 back in the condition shown in FIG. 4. Thus the pipe 16 remains clamped by the jaws 96 of the pipe holder 18, but the tool holder 26 has been retracted sufficiently to be clear of the flared end of the pipe. The user then indexes the tool holder 26 across the pipe flaring apparatus 10 to bring a desired second flaring tool into alignment with the pipe (alternatively the tool holder 26 can be removed from the pipe flaring apparatus and a substitute tool fitted to the tool holder, which is then reinserted in the apparatus). The user then squeezes the trigger 28 as previously described to cause the new tool to be driven into the end of the pipe to form a second flare. Once the second flare is formed, the user can return the pipe flaring apparatus 10 to the rest condition shown in FIG. 1 by simply moving the release lever 43 to its second release position. The forces stored in the force transmitting member 63 and return member 110 will cause the toothed member 34, piston 38, pusher 52 and pipe holder 18 to be returned from their positions shown in FIG. 5 to the position shown in FIG. 1. Once the jaws 96 of the pipe holder have released the pipe 16, the pipe can be removed from the pipe flaring apparatus 10.

It will be appreciated that the end regions of the jaws 96 can be shaped so as to form a partial die that would support the exterior of the pipe in the region being flared to assist in the formation of a correctly shaped flare.

It will be appreciated that by providing a pipe holder 18 having a number of circumferentially-spaced jaws that can be moved into clamping engagement with a pipe, it is possible to obtain a better grip than is obtainable with a two-part split die. This is particularly the case if the pipe is not perfectly round. The pipe holder may have any number of jaws, but preferably has at least three so as to make the pipe holder self-centring.

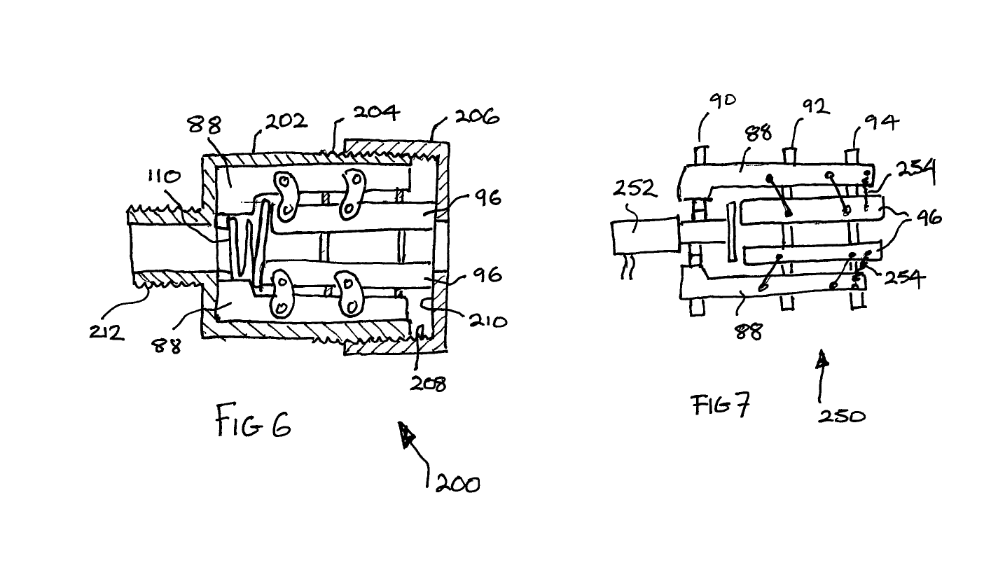

It will be understood that while the gripping device has application in a pipe flaring apparatus as described above, it has many other applications. For example, as shown in FIG. 6, a self-centring chuck 200 could be formed by installing the assembly shown in FIG. 3 in a cylindrical housing 200 having a region provided with external threading 204 and having a sleeve 206 provided with internal threading mounted on the cylindrical housing such that rotation of the sleeve relative to the housing causes an inner end face 210 of the sleeve to press against the jaws 96 in the manner of the pusher 52. The sleeve 206 may have an exterior surface provided with gripping, formations, for example knurls, to facilitate tightening of turning of the sleeve to tighten the jaws onto a part to be gripped. Alternatively, the sleeve may have a polygonal exterior surface to enable tightening by means of a simple gripping tool. Alternatively, the threading may be omitted from the cylindrical housing 200 and sleeve 206 and an over-centre lever arrangement provided for drawing the sleeve onto the housing to close the jaws onto a part to be gripped.

The cylindrical housing may have an externally threaded spigot 212 for attachment to a drive spindle. Alternatively, the spigot 212 may have external threading or the cylindrical housing may have a back plate provided with means, such as thread holes and/or locating pin holes by which it may be fixed and/or located to a drive device.

It will be understood that the gripping device may be actuated by means other than the arrangements shown in FIGS. 1 to 6. For example, as shown in FIG. 7, a gripping device 250 may be provided with an electromagnet 252 for drawing the jaws 96 into the support frame a biasing force provided by, for example, a plurality of tension springs 254. Such a gripping device could be used as a clutch for gripping a periphery of a shaft. Such a clutch might be used in machinery requiring a relatively fast light gripping action. The clutch may also be fitted to a bicycle to act as a bicycle brake.

It will be appreciated that for some applications, it may be desirable to provide the jaws with a modified gripping surface. For example, the jaws may be fitted with a U-section boot made of a material have desired properties. For example, the boot may be made of a high friction material to improve the grip provided or a relatively soft material to protect the part to be gripped.

It will be understood that the simple construction of the gripping devices of the embodiments makes it possible to provide multiple jaws economically. For example, a gripping device having 6, 8 or 10 jaws could be manufactured economically and having an increased number of jaws should improve gripping performance when gripping parts that are irregular or not concentric. For example, a six jaw chuck is envisaged for gripping the fluted portion of a drill in a drill sharpening machine.

1. A gripping device comprising:
a support frame having a lengthways extending axis and defining an axially extending internal space for receiving a part that is to be gripped; and
a plurality of jaws carried by said support frame,
wherein said jaws each have an end face and are connected with said support frame such that an axially directed force applied to said end faces causes axially and radially inward movement of said jaws for gripping a said part received in said internal space.

2. A gripping device as claimed in claim 1, wherein each said jaw is connected to said support by two spaced apart links to define a four bar linkage.

3. A gripping device as claimed in claim 2, wherein each jaw is a plate member.

4. A gripping device as claimed in claim 1, wherein said support frame comprises a plurality of interengaging plates.

5. A gripping device as claimed in claim 4, wherein said interengaging plates are push-fit connectable.

6. A gripping device as claimed in claim 4, comprising a sleeve for said support frame, said sleeve being arranged to prevent radial separation of said interengaging plates.

7. A gripping device as claimed in claim 4, wherein said support frame comprises a plurality of annular discs and a plurality of elongate jaw carrier plates, said discs each having a plurality of radially extending slots in which said elongate jaw carrier plates are received.

8. A gripping device as claimed in claim 7, wherein said annular discs are disposed perpendicular to a longitudinally extending axis of said gripping device and said elongate jaw carrier plates are disposed parallel to and spaced from said longitudinal axis.

9. A gripping device as claimed in claim 1, comprising at least one biasing device for biasing said jaws in a direction opposite to said axially inward movement.

10. A gripping device comprising:
a support frame; and
a plurality of jaws carried by said support frame,
wherein said support frame comprises a plurality of plate members that are in fixed meshing engagement.

11. A gripping device as claimed in claim 10, wherein said meshing plate members are push-fit engageable.

12. A gripping device as claimed in claim 10, wherein said plate members comprise a plurality of elongate members extending parallel to a longitudinal axis of said gripping device and a plurality of transverse support members, said jaws being pivotably connected with said elongate members.

13. A gripping device as claimed in claim 12, wherein said support members are provided with slots for receiving said elongate members.

14. A self-centering chuck comprising:
a gripping device, said gripping device comprising a support frame having a lengthways extending axis and defining an axially extending internal space for receiving a part that is to be gripped, and a plurality of jaws carried by said support frame,
wherein said jaws each have an end face and are connected with said support frame such that an axially directed force applied to said end faces causes axially and radially inward movement of said jaws for gripping a said part received in said internal space.

15. A clutch comprising:
a gripping device, said gripping device comprising a support frame having a lengthways extending axis and defining an axially extending internal space for receiving a part that is to be gripped, and a plurality of jaws carried by said support frame,
wherein said jaws each have an end face and are connected with said support frame such that an axially directed force applied to said end faces causes axially and radially inward movement of said jaws for gripping a said part received in said internal space.

16. A method of manufacturing a chuck or clutch, said method comprising providing a plurality of plates members, forming a support frame by connecting a first plurality of said plate members and pivotally connecting a second plurality of said plate members to said support frame to define a plurality of pivoting jaws.

17. A method of manufacturing as claimed in claim 16, comprising pivotally connecting each said pivoting jaw to said support frame by two link arms to form a four bar linkage.

18. A method of manufacturing as claimed in claim 16, wherein said first plurality of plate members include a plurality of transverse support members having an axial through hole that is coaxial with the longitudinal axis of the chuck or clutch.

19. A method of manufacturing as claimed in claim 18, wherein said first plurality of plate members includes a plurality of elongate jaw carrier members that extend parallel to said longitudinal axis.

20. A method of manufacturing as claimed in claim 19, wherein said first plurality of plate members includes plate members provided with recesses for receiving other said plate members of said first plurality of plate members.

21. A method of manufacturing as claimed in claim 16, wherein said support frame is formed by push-fit connecting said plate members.

22. A method of manufacturing as claimed in claimed in claim 16, wherein said plate members are formed by pressing or stamping.

23. A pipe flaring apparatus comprising:
a gripping device to grip an end region of a pipe to hold said pipe against axial movement thereof; and
a flaring tool holder movable to bring a pipe flaring tool into engagement with said pipe to produce a flare at a free end of said end region,
said gripping device comprising:
a support frame having a lengthways extending axis and defining an axially extending internal space for receiving a part that is to be gripped; and
a plurality of jaws carried by said support frame,
wherein said jaws each have an end face and are connected with said support frame such that an axially directed force applied to said end faces causes axially and radially inward movement of said jaws for gripping a said part received in said internal space.

24. A gripping device as claimed in claim 23, wherein each said jaw is connected to said support by two spaced apart links to define a four bar linkage.

25. A gripping device as claimed in claim 24, wherein each jaw is a plate member,

26. A gripping device as claimed in claim 23, wherein said support frame comprises a plurality of interengaging plates.

27. A gripping device as claimed in claim 26, wherein said interengaging plates are push-fit connectable.

28. A gripping device as claimed in claim 26, comprising a sleeve for said support frame, said sleeve being arranged to prevent radial separation of said interengaging plates.

29. A gripping device as claimed in claim 26, wherein said support frame comprises a plurality of annular discs and a plurality of elongate jaw carrier plates, said discs each having a plurality of radially extending slots in which said elongate jaw carrier plates are received.

30. A gripping device as claimed in claim 29, wherein said annular discs are disposed perpendicular to a longitudinally extending axis of said gripping device and said elongate jaw carrier plates are disposed parallel to and spaced from said longitudinal axis.

31. A gripping device as claimed in claim 23, comprising at least one biasing device for biasing said jaws in a direction opposite to said axially inward movement.

32. A holding apparatus for holding an elongate element against axial movement, said holding apparatus comprising:
a support having a longitudinal axis and defining an internal space for receiving a said elongate element; and
a plurality of jaws mounted to the support for axial and radial movement relative to the support, wherein axial movement of the jaws into the support causes the jaws to move radially inwardly of the support for engaging and holding a said elongate element received is said space.
